(19) United States
(12) Patent Application Publication
(10) Pub. No.: US 2011/0017944 A1
(43) Pub. Date: Jan. 27, 2011

(54) Method for Encapsulating Latent Heat Storage Material and Products Obtained Thereby

(75) Inventors: Ruth Houbertz-Krauss, Werneck (DE); Gerhard Sextl, Hochberg (DE); Uta Helbig, Wurzburg (DE); Daniela Platte, Wurzburg (DE); Anu Punnoose, Wurzburg (DE)

Correspondence Address: GUDRUN E. HUCKETT DRAUDT, SCHUBERTSTR. 15A, WUPPERTAL, 42289, DE

(73) Assignee: UNIVERSITAET WUERZBURG, Wuerzburg (DE)

(21) Appl. No.: 12/933,177

(22) PCT Filed: Mar. 13, 2009
(86) PCT No.: PCT/EP2009/053016

§ 371 Date: Sep. 17, 2010

(30) Foreign Application Priority Data
Mar. 19, 2008 (DE) 10 2008 015 302.8

(51) Int. Cl. C09K 5/00; B01J 13/18

(52) U.S. Cl. 252/70; 264/4.7

(57) ABSTRACT

The invention relates to a method for producing an inorganic latent heat storage material that is surrounded by an encapsulating layer that is made of an inorganic-organic polymer material that comprises a metal and/or semi-metal oxygen network with embedded organic groups. The method is characterised in that a liquid or liquefied latent heat storage material, in the form of discrete units that are to be, respectively, encapsulated, is introduced into a liquid or viscous precursor material of the encapsulating material such that the encapsulating material solidifies when coming into contact with the outer surfaces of said latent heat storage material. The invention also relates to an inorganic latent heat storage material that is surrounded by an encapsulating layer and is present in said encapsulation, said encapsulating material being made of an inorganic-organic polymer material that comprises a (semi) metal oxygen network with embedded organic groups, connected, preferably at least partially to (semi) metal. Silane resins are well suited as precursor material.

The present invention is directed to encapsulated materials useful for the reversible storage of energy in the form of latent heat. Moreover, it is directed to a process for encapsulating such materials.

Latent heat accumulators are used for the thermal storage of energy. Hence, they are designated and used as a kind “of thermal battery”. As latent heat storage materials which are also called phase change materials (PMC), different substance classes are suitable. It is a prerequisite that the materials in the temperature range relevant for the application pass through a phase transition process. These phase changes should be connected with a high amount of transformation heat and be reversible. Well suited are, for example, organic materials like paraffines, in particular C₁₄-C₃₀ alkanes, polyethylenglycole, polyoles, cross-linked polyethylenes (see Lane, G.A., Solar Heat Storage: Latent Heat Materials, Vol.2: Technology Boca Raton Fla., CRC Press Inc., 2nd Ed. 2000) or fatty acids. The advantages of the organic PCMs are the wide range of the transition temperatures, the low trend towards overcooling prior to crystallization and congruent melting. Nevertheless, compared with inorganic PCM materials they show a worse thermal conductivity and a low accumulator density. Besides, organic PCMs show a higher fire load. The advantage of inorganic PCMs to which in particular salt hydrates belong lies in the higher accumulator density, above all. Although the transformation heats of these materials are approximately comparable with those of organic PCMs, with reference to the respective molar amounts, about twice the accumulator density can be achieved, because in particular salt hydrates show higher densities. Nevertheless, inorganic latent heat accumulators are frequently incongruently melting substances and, hence, tend to segregation with increasing cycle number.

Most latent heat accumulators must be operated in suitable containers, because they are in liquid status, if they are in loaded condition (melting enthalpy taken up). The containers must be sufficient for a number of demands: They must be mechanically stable and chemically resistant for the material PCM and they must have a sufficiently high thermal conductivity. They should be resistant to temperature in the operation range, but preferably also beyond it. A good barrier effect against water and other highly volatile components is to be aimed, e.g., to prevent that a diluting medium possibly present or even the crystal water of salt hydrates can evaporate.

The containers can be provided in different geometries, adapted to the application. For many applications it is practical that the latent heat accumulator material is encapsulated. Because every increase of the surface increases the thermal conductivity and a spatial phase separation becomes less likely in small volumes, on the other hand, the encapsulation material reduces the storage capacity per unit of weight, an encapsulation is to be aimed in the mm scale or μm scale (in capsules with diameters of 1 to 10 mm or from 1 to 1000 μm, respectively) as optimum. Microcapsules serve as active components in PCM-slurries and can be incorporated into materials like building materials and textiles. In addition, a microencapsulation is favorable particularly for inorganic PCM materials, because a possible segregation of the materials can be prevented during the thermal cyclization, due to the narrowness of the capsule compartments.

Encapsulated organic accumulator materials are known and are already commercially used in specific cases.

As mentioned above, in particular salt hydrates are suited as inorganic PCM materials. This term ist to be understood to designate salts which crystallize together with water molecules which melt at relatively low temperatures in their own crystal water. Their melts lie structurally between the simple salt melts and the salt solutions. The salt hydrates, accessible otherwise or commercially, have melting points mainly in the range of from about 7 to 117° C. They show different phase equilibrium ratios. For example, Mg(NO₃)₂×6 H₂O has a completely congruent melting point, while for example Na₂SO₄ ×10 H₂O does not only melt incongruently, but shows even an inverse ratio of temperature/solubility. All materials have a considerable water vapor pressure which rises with rising temperature. Other examples of congruently melting salt hydrates are CaCl₂×6 H₂O (pure or modified) or KF×4 H₂O. Other salt hydrates melt quasi-congruently, congruently isomorphically or incongruently, i.e. during melting, a separation takes place into a higher melting salt hydrate with a lower content of water and a liquid phase with a higher content of water. The separation is often irreversible, because a spatial separation of the phases takes place, which, however, can largely be prevented by providing small-scale compartments e.g. microcapsules or the like. Moreover, the incongruence of the melting point of many salt hydrates can be overcome by the addition of small quantities of water. Farther examples of salt hydrates can be found in Lane, G.A., vide supra. A typical basic, non-hygroscopic salt hydrate having an incongruent melting point of 32 to 36° C. and a melting heat of about 247 kJ/kg is sodium carbonate decahydrate. Because sodium carbonate (soda) is a cost efficient bulk product, it is obviously a suitable PCM for the present invention, besides other salt hydrates. By addition of small quantities of water (e.g., 10% by weight), a congruent melting point is obtained; from the diluted melt the decahydrate crystallizes again. Another salt hydrate which is especially worth mentioning and is favorable for the invention is a mixture of 17 wt. % Na₂CO₃, 15 wt. % Na₂HPO₄ and 68 wt. % H₂O. This mixture already contains the small amount of water as previously mentioned, so that a congruent melting point or a clear melt, respectively, can be achieved. The hydrates being effective as PCM in this case are sodium carbonate decahydrate and sodium hydrogen phosphate dodecahydrate. The combination of these both salts is described in H. Zhan et al., J. Therm. Anal. (1995) 45, 109-115. The combination is characterized by a very low melting point (approx. 23° C.), so that it is specifically suited in encapsulated form for the application in buildings (constructions).

The previously mentioned salt hydrates are to be distinguished from anhydrous salts which can take up water molecules in their crystal lattice under loss of heat. Although this reaction is reversible in principle as well, the reverse reaction taking place under absorption of heat can only occur by separating the water molecules spatially from the respective salt. However, only such materials can be used as encapsulated PCMs which allow a reversible storage of heat without intermediate separation of their components. Accordingly, the microencapsulated, heat delivering materials of WO 2007/075208 A1 which contain anhydrous calcium chloride are suited only for the unique employment, for example, for cosmetic products. These microcapsules are encapsulated with an alginate and, as a matter of principle, such that appearing water or appearing humidity comes in contact with the salt, by which heating is caused.

Accordingly, the expression “heat accumulator material” is used in the present invention for such materials only which can reversibly store heat, without being required to be present in the form of separate components in one of the two different conditions which they can adopt.

For the encapsulation of different core materials, a number of methods is known. Siddhan, P. et al. in J. Appl. Polymer Sci. 106, 2007, 786-792 describe the microencapsulation of n-octadecane in polyurea with the aid of interface polymerization. With this method, the polymer which forms in liquid phase is precipitated on the surface of drops which form the core material. Liu, W.-J. et al. in Polym. Int. 55, 2006, 520-524 show the encapsulation of hydrophobic polystyrene with hydrophilic polymethacrylic acid using a two-step emulsion polymerization in the absence of emulsifier. Wang, L.-Y. et al. in J. of Microencapsulation 23 (1), 2006, 3-14, present a process for encapsulating n-pentadecane with an inorganic silicon envelope with the aid of sol gel technology (starting with tetraethoxysilane) in an o/w emulsion. Microcapsules with a wall structure made of silicone and a core of lipophilic, organic, liquid substances which are known from DE 199 54 772 A1 have latent heat accumulator ability; also they are produced from an o/w emulsion. However, o/w emulsion processes are not suitable for encapsulating inorganic materials, because these are far too polar.

Hence, it is the problem of the present invention to elaborate a process by which inorganic PCMs can be provided with a coating, thereby encapsulating the same. The problem furthermore lies in the provision of PCMs which are encapsulated accordingly.

This problem is solved by the proposal to encapsulate inorganic, in particular polar PCMs like salt hydrates in an inorganic-organic polymer material which is built up from a metal (and/or half metal) oxygen network with incorporated organic groups which are at least partially bonded to the (half) metal. In particular, the said material is a modified organopolysiloxane which is optionally modified (e.g., by other metal atoms). The encapsulation is present in the form of a layer-shaped capsule which is closed around the core of PCM.

Inorganic-organic materials are known in great number. The ORMOCER®s which were developed in the Fraunhofer institut für Silicatforschung are a large group thereof. These can be regarded as organopolysiloxanes or hydrolytic condensates of (half) metal compounds, in particular silicon compounds, which are modified by organic residues (organically polymerizable/polymerized or not polymerizable) which are bound to (half) metal atoms. Beside silicon compounds, other hydrolyzable/hydrolyzed metal compounds, e.g., of aluminum, boron, germanium and the like, can be present.

The production of organically modified polysiloxanes or silicic acid condensates (often likewise called “silane resins”) and their properties have been described in an abundance of publications. Substitutionally, reference is made here to Hybrid Organic-Inorganic Materials, MRS Bulletin 26(5), 364ff (2001). In general, such substances are regularly produced using the so-called sol gel process, wherein monomeric or precondensated silanes which are sensitive to hydrolysis, if necessary in the presence of other cocondensable substances like alkoxides of boron, germanium or titanium, as well as of additional compounds which may serve as modifiers or network converters, or of other additives like dyes and fillers, are subjected to a hydrolysis and condensation reaction.

The encapsulation material of the present invention is preferably built up from at least one silane of the formula

RₐR′_{b}SiX_{4-a-b} (I)

or using such a silane wherein the substituents R, R′ and X may have the same or a different meaning and wherein R is an organically crosslinkable radical which is bonded to the silicon via carbon, R′ is an organically non-crosslinkable radical which is bonded to the silicon via carbon, X is a group which may be cleaved from silicon under hydrolytic conditions, or is OH, a is 0, 1 or 2, b is 0, 1 or 2, and a+b must be 1 or 2 and is preferably 1.

The crosslinking of the radical R can occur via one or more groups through a radical or cationic polymerization. In this connection, the term “polymerization” shall mean a polyreaction wherein reactive double bonds or rings are converted into polymers under the influence of initiators, of heat, light or ionizing radiation (in English: addition polymerization or chain-growth polymerization). For example, a cationic polymerization can take place with the aid of a cationic UV starter, for example, with an epoxy system (see e.g. C.G.Roffey, Photogeneration of Reactive Species for UV Curing, John Wiley & Sons Ltd, (1997)). Hence, examples for R are radicals with one or more non-aromatic C=C double bonds, preferably double bonds which can be subjected to a Michael addition, like styryles or (meth)acrylates. Alternatively, the crosslinking can occur through other polyreactions like ring-opening polymerization, ester formation and the like. In specific embodiments, this polyreaction can take place directly, e.g., between an epoxy-containing residue R on a first silane of the formula (I) and an amine-containing residue R on a second silane of the formula (I). In other specific embodiments, the crosslinking takes place via a crosslinking agent, for example, a diamine for crosslinking silanes of formula (I) which contain a glycidyl residue on the radical R. As a rule, the radical R contains at least two and preferably up to approx. 50 carbon atoms.

The radical R′ cannot undergo such a reaction. Preferably, it is an optionally substituted alkyl-, aryl-, alkylaryl- or arylalkyl group the substituents of which do not allow a crosslinking, wherein the carbon chain of these radicals can optionally be interrupted by O, S, NH, CONH, COO, NHCOO or the like. Preferred are radicals R′ with from 1 to 30 or up to 50, more preferred from 6 to 25 carbon atoms. Unsubstituted or fluorinated alkyl groups having such a large number of carbon atoms are particularly preferred, because they may contribute to a low water-vapour permeation.

The group X in formula (I) is a group which can be cleaved from the silicon under hydrolytic conditions. The groups which are suitable for this are known to the skilled person from the state of the art. As a rule, the group X is hydrogen, halogen, hydroxy, alkoxy, acyloxy or NR″₂, wherein R″ is hydrogen or a lower alkyl (preferably with from 1 to 6 carbon atoms). Alkoxy groups are preferred as cleaving groups, in particular lower alkoxy groups like C₁-C₆ alkoxy.

Because the index a as well as the index b can be 0, the silane of the formula I can have either one or two radicals R or one or two radicals R′. Alternatively, one radical R and one radical R′ can be present. The alternative which has two radicals R is preferred beside other variants because a high organic crosslinking causes a high density (impermeability) of the encapsulation and accordingly, a low water vapour permeation rate.

The preferred encapsulation material of the present invention is usually formed by hydrolysis and condensation of silanes of the formula (I) (optionally in the presence of further components like metal alkoxides), wherein not necessarily, but in the preferred cases, this is followed by a crosslinking via the radicals R. The advantage lies in the fact that silicon polycondensates which are not cross-linked have a very low flexibility, so that they rather tend to cracking and are susceptible to stress. Alternatively (however, in rather rare cases) the material can be polymerized exclusively by crosslinking via the radicals R of the basic silanes.

The encapsulation material can have been prepared under use of at least one further silane of the formula (II)

SiX₄ (II)

wherein X is identical or different and has the same meaning as in formula (I). A compound well applicable for this is tetraethoxysilane. By addition of such silanes to the mixture which is to be hydrolyzed and condensed and from which finally the encapsulation material forms, the SiO proportion of the resin, that is the inorganic proportion, is increased. The permeability for gases, and accordingly that for water vapour, can thereby be reduced; however, a disadvantage is that materials having a high inorganic proportion are more brittle than those with a low inorganic proportion. Hence, they rather tend to stress and cracking.

Instead, or if desired in addition, the encapsulation material of the invention can have been prepared using at least one silane with the formula (III)

RₐR′₃₋ₐSiX (III)

wherein R, R′ and X have the meaning previously indicated for formula (I). The organic proportion of the material thereby increases, and this improves the elasticity of the material.

The encapsulation material according to the invention can contain further substances, e.g., preferably lower alkoxides, in particular C₁-C₆ alkoxides of metals of the III^{rd} main group, of germanium and of metals of the II^{nd}., III^{rd}., IV^{th}, V^{th}, VI^{th}, VII^{th}, and VIII^{th} subgroup.

Examples of materials which are well applicable according to the invention are those as disclosed in WO 03/031499 or WO 03/037606.

As previously explained, salt hydrates have a noticeable vapor pressure. Therefore, it is favorable to use encapsulation materials with good barrier qualities for the permeation particularly of water vapor. Such materials are known. Thus, EP 0644908 B1 describes silicone-based laquers, made by means of sol gel processing, and their use as substrate coatings. These materials are especially well suited when used under very rough ambient conditions, thus in particular as passivation and encapsulation materials against humidity. In the area of the passivation of (micro)electronic components as for example SMT (surface mount technology) components or as a structured layer in multiple layer constructions, hybrid polymers were exclusively used as a final or sealing encapsulation layer (structureable barrier layers against water vapor/humidity), see Houbertz R. et al., Mat. Res. Soc. Symp. 665, 2001, 321-326. The water vapour permeation rates of the hybrid polymers can be controlled via the proportion of inorganic component as well as via the organic functionalities. For passivating, structureable hybrid polymers, WTR values of from approx. 1 to 3 g/m²d (with reference to a coating thickness of 100 μm) were published, see Houbertz et al., Mater. Res. Soc. Symp. 769, 2003, 239-244. Accordingly, salt hydrates are favorably encapsulated using encapsulation materials on the basis of the silanes or lacquers mentioned in these publications.

As a rule, the encapsulation of inorganic materials cannot take place via an emulsion process. Hence, the invention provides a novel, completely differing process to encapsulate the PCMs.

This process is characterized in that liquid or liquefied PCM material is introduced, preferably dropped, into a liquid or viscous precursor material of the encapsulation material, so that the encapsulation material hardens upon contact with the PCM material on the exterior surfaces thereof, while the PCM material, as a rule, is converted at the same time (e.g., by cooling) from the liquid into the crystalline phase.

If the encapsulation material is to be prepared from a silane having formula (I), or using the same, preferably a laquer is used as the precursor material which was produced by at least partially performed hydrolysis and condensation of a basic material which contained the silane with the formula (I). In rare cases, the precursor material may instead include the silane of the formula (I) in not yet hydrolyzed/condensed form. The solidification then occurs via crosslinking of the radicals R of the (partial) condensate obtained from silanes with the formula (I) or using same, and/or by an inorganic crosslinking (condensation) of the not yet or not yet completely hydrolyzed and condensed precursor material, in the preferred cases.

The precursor material is usually produced with the aid of the so-called sol gel process from the monomer metal compounds, in particular of the respective silanes. It can be present without diluting medium or may contain—preferably relatively small amounts of —a diluting medium, e.g., water and/or alcohol (optionally e.g. as a remainder from the hydrolytic condensation reaction), or may contain a nonpolar solvent (e.g., if the material is relatively hydrophobic) or can be dissolved therein. With the aid of diluents, a suitable viscosity can mostly be adjusted as well

Concerning this it is to be noted that the crosslinking does not proceed all of a sudden in most cases, but takes some time. For this time period, it must be ensured that the surface of the PCM material incompletely in contact with the coating bath. If this was not ensured with safety, an only partial coating would result. Therefore, the viscosity should be selected preferably in such a way that drops impinging on the surface of the material only slowly sink into it, so that they do not immediately impinge on the bottom of the vessel in order to ensure a crosslinking all around the drops. The geometry of this vessel may contribute to this: long, high vessels are particularly suitable. Further (in addition or alternatively), the viscosity can also be increased if required, by adding a thickening agent to the precursor material or its solution in a diluent. Instead, or in addition, the density of the coating bath can resemble that of the latent accumulator material to be encapsulated or can be the identical with that of the latent accumulator material. In this manner one can achieve that the drops float in the coating bath or sink to the bottom only extremely slowly.

As thickening agents, materials are suitable which impart thixotropy to the coating bath or have at least an anti settling effect. For this, for example particles having diameters in the nanometer range (e.g., particles in the range of from approx. 6 nm, but also in particular particles which are aggregated from smaller particles, having diameters in the 100-nm range) are suitable which interact with components of the bath such that they form e.g. a network of Van-der-Vaals forces, like hydrogen bridges. These can be hydrophilic if required, as for example the powder of [Si-O]ₓ particles having numerous silanol groups on its surface which is distributed under the trade name Aerosil ® 380 of Degussa or Evonik, respectively. In particular in nonpolar solutions, this material can build up a network of hydrogen bridges by which thickening up to gelation may occur which can easily be reversed again by addition of a nonpolar solvent like toluene. Of course, less hydrophilic additions are also suitable which the skilled person can find without additional measures, for example so called sedimentation retarder which can be merely organic and which may consist e.g. of unbranched polyethylene chains, or similar means. These are even more favorable for the case that salt melts are to be used as the latent heat accumulator, because they do not reduce the hydrophobicity of the encapsulation material when incorporated therein, which is usually inevitable, which can be important in view of the water vapor barrier effect of the encapsulation in many cases.

The crosslinking can be caused on different ways.

In a first variant, the organic and/or inorganic crosslinking of the precursor material is caused by energy incorporation, without a catalyst becoming necessary. The energy for this is preferably introduced in the form of heat. For this, the energy of phase transition of the PCMs (heat of solidification in case of salt hydrates) can be used: The liquefied/liquid PCM material is introduced, e.g. in the form of drops, into an encapsulation precursor material having a suitable, lower temperature, such that it solidifies at the same time. The nascent energy on the surface of the drops then causes the inorganic and/or organic crosslinking of precursor material on this surface: it forms a capsule around the drop. One example of such a variant is the provision of encapsulation precursor material using two different silanes with the formula (I), of which one contains a radical R which can react with the radical R of a second silane of the formula (I) (e.g., amine-containing radical R with epoxy containing second radical R; crosslinking under formation of NH-CO groups). Besides, attention is of course to be paid to the fact that the precursor material should be sufficiently cooled in order to suppress a crosslinking in absence from PCM as much as possible.

In a second variant, crosslinking is also provided without catalyst; nevertheless, it occurs with the aid of a cross-linking agent which is present either in the PCM or in the encapsulation precursor material. Such a cross-linking agent can be, for example, an oligoamine (e.g., a diamine) or an oligoepoxide (e.g., a bisepoxide) which cross-links radicals R of the silane of the formula (I) to an epoxy or amine group under formation of amido groups. If the cross-linking agent is added to the PCM, the risk of an untimely crosslinking of the precursor material is prevented. Indeed, in this case it must be compatible with the PCM and may not suppress the conversion thereof. If it is added to the precursor material, attention must be paid, like in the first variant, to the fact that the temperature should be sufficiently low. The cross-linking agent should be selected preferably in such a way that it already reacts at relatively low temperatures. An example of such a cross-linking agent is triethylene tetramine.

In a third variant, the crosslinking is caused by the action of a catalyst or initiator. This can consist either of one component, whereby it is used like the cross-linking agent of the second variant, but makes the provision of additional crosslinking energy superfluous. Instead, the catalyst/initiator may consist of two components which must cooperate in such a way that the crosslinking occurs. One of these components is added to the PCM, the other to the precursor material. If the PCM is introduced in the precursor material, both components cooperate at the exterior surfaces of the introduced drops, and an encapsulation from cross-linked precursor material is formed.

In a first, indeed, less preferred embodiment, such initiators can initiate either a hydrolytic condensation of the precursor material, provided that the precursor material consists of monomers (silanes and if necessary metal alkoxides), or can complete this hydrolytic condensation, if the precursor material contains a precondensate of the monomers. An example for this is the basically catalyzed polycondensation of arylsilanedioles with methacrylate group containing trialkoxysilanes as it is described in DE 199 32 629 A1. Besides triethylamine or ammonium fluoride, earth alkali hydroxides like Ba(OH)₂ are well suited as initiators for this polycondensation. These compounds can be added to basic salt hydrates being PMCs especially well; in a special case, salt hydrate and earth alkali hydroxide can be even identical. This special case is very similar to the above, first variant because the encapsulation energy can be introduced without other measures, exclusively by incorporation of the PCM, into the precursor material.

In a second, stronger preferred embodiment of the third variant, the crosslinking of the precursor material about groups R is caused with the aid of the initiator system consisting of one or more components. Examples of the initiator systems which cause such a crosslinking are redox initiator systems like ammoniumperoxodisulfate (APS) in combination with a reducing agent like tetramethylene ethylenediamine (TMEDA) or ferrocene. Because APS is relatively stable in the alkaline environment, it is suitable for an addition to the PCM. As a rule, APS is completely dissolvable in salt hydrate melts; it does not hinder the crystallisation of the salt hydrate from the melt. In such cases, the reducing component is added to the precursor material. As a rule, varnishes from hydrolytically condensed silanes of the formula (I) are stable at room temperature or below for months. Relative to the selection of the reducing agent, mixtures can be obtained which are also stable for a long time and therefore can be produced in large quantities in advance.

The different variants can be also combined in a suitable manner. For example, the heat liberating during dropping-in of the PCM can be used for crosslinking in addition to a catalyst. This is not only, but in particular possible if crosslinking is effected inorganically (in form of a hydrolytic (first or subsequent) condensation) as well as organically.

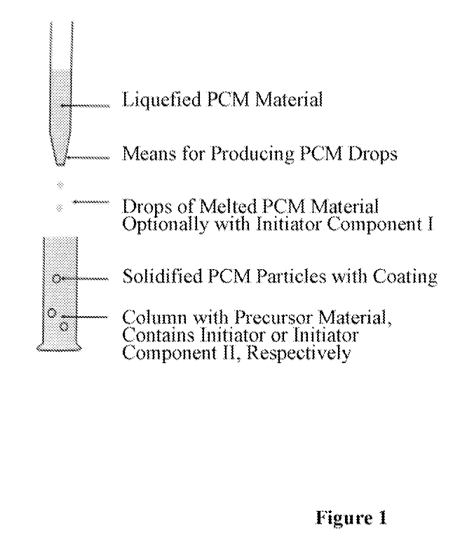

In an exemplary process, drops of about 0.05 to 4 mm, preferably from about 0.5 to 1.5 mm, of liquefied latent heat accumulator material which optionally has been diluted in a suitable manner and/or to which optionally a crosslinking agent or initiator has been added, are carefully (preferably from a low distance, in order to achieve a round geometry as good as possible) incorporated into the encapsulation material. This is shown in FIG. 1 schematically. The drops mostly have a temperature above the melting point of the respective PCM which therefore should usually lie above 10 to 120° C. (since subcooled melts exist, however, this is not always compelling); for reasons of an easy handling (and, for example, favorable when sodium carbonate salt hydrate is used) temperatures of 30-45° C. are preferred (diluted sodium carbonate decahydrate with a proportion of 27 wt. % Na₂CO₃ is liquid above 35° C.). The encapsulation material is cooled down to a temperature below the melting point of the PCM material, e.g., approx. −5 to −30° C. After a short time the encapsulated drops are separated from the coating material. If it is desired to obtain a relatively thin encapsulation layer, the encapsulated drops can be washed immediately after isolation with a suitable solvent, e.g., with the diluting agent of the precursor material, in order to separate adhering precursor material which is not yet completely cross-linked. If a relatively thick encapsulation layer is aimed, the encapsulated drops are dried without further treatment, e.g., in the air at room temperature or mild elevated temperatures.

According to the respective requirements, larger or, above all, smaller drops (up to the range of from 1-50 μm) can be encapsulated.

The previously described process can of course also be applied to organic latent heat accumulator materials. In such cases, a paraffin or the like is used instead of the salt hydrate or other inorganic PCM. The surface also of these materials can serve as a substrate for the crosslinking of the inorganic precursor material.

The encapsulation materials suggested for the inventive process have good layer forming properties and—in case of a suitable choice of the underlying silanes as explained above—good passivation properties (WVTR<3 g/m², calculated for 100 μm of coating thickness). As required, good mechanical properties may be achieved, as well as a good resistance of the coating, in particular against chemicals and solvents. The surface properties of the encapsulation can be controlled to be provide the suitable parameters, in a wide range. Provided that one refrains from the addition of toxic metal alkoxides, as it should be the rule, the encapsulations own a low toxicity. The coating can be made opaque or transparent, optionally also coloured (by the addition of metal ions or from dyes), by the application of suitable silanes of the formula (I).

PCM materials encapsulated with the encapsulation materials according to the invention can be introduced in principle in different matrices. The capsules, in particular in the form of microcapsules (i.e. with diameters from below 1 mm to 0.05 mm, if necessary even to down to 1 μm) can be introduced into thermally active slurry as an active component. Furthermore the (micro) capsules can be integrated, for example, into building materials, textiles and other materials, for storing energy. In this connection, the advantages of the use of microcapsules lie in the fact that an additional manufacture and sealing process is not necessary as for example in the case of introduction into containers. Nevertheless, in some cases it can be convenient to seal the single capsules even further, for example, by coating their exterior surfaces with open (e.g., patterned) or closed (continuous) metal or metal oxide layers or such which can provide additional properties to the capsules. One of these properties is an even more improved barrier effect, e.g., against water, water vapour or other gaseous substances, as it is known, e.g., for metal and metal oxide layers. Techniques for the application of such materials, from the gas phase as well as by chemical separation processes, are available for the expert in great extent.

### Example 1

2217 g (100 mol %; 12 mol) [2-(3,4-epoxycyclohexyl)ethyl]-trimethoxysilane are hydrolytically condensed with 3.33 g (0.12 mol) NH₄F and 257 g of water in 3190 g diethyl carbonate (36 mol). Subsequently, the solvent is removed at 40° C., the product is subjected to a pressure filtration. The inorganic portion of this material is adjusted to 28 wt. %, in relation to the total molar mass.

The resin formed is used in undiluted form or diluted in toluene (having a concentration of at least 80 wt. % of resin). Immediately prior to use, triethylenetetramine is added in an amount of 0.16 mol per mol silane, and the solution is immediately filled into a column and is cooled to less than 10° C., preferably from −10 to −20° C.

Sodium carbonate decahydrate containing 27 wt. % of sodium carbonate is heated to 35° C., where it melts. Drops are dripped into the cooled resin from a distance of less than 1 cm by a warmed up metal cannula having a diameter of 0.42 mm. After solidifying of the melt, the coated drops are removed mechanically from the coating solution. Some drops are washed immediately afterwards with toluene to remove unreacted resin, other drops are left untreated. All capsules are dried in air at ambient temperature. They contain crystalline sodium carbonate decahydrate in the core which is surrounded by the polymerized polysiloxane layer. The latter has a thickness of approx. 100-200μm in the unwashed capsules. The barrier effect of the layer is good, but is not complete.

### Example 2

Example 1 is repeated, but using an acrylate containing silane resin as the encapsulation material which has an inorganic portion, with reference to the total molar mass, of approximately 10 wt. %.

For the production of this silane resin, the Michael adduct is produced first from 355.58 g (120 mol %, 1.2 mol) trimethylolpropanetriacrylate and 180.34 g (100 mol %, 1 mol) mercaptopropylmethyldimethoxysilane in 1200 ml ethyl acetate with the addition of 68.31 g of a 1 wt. % ethanolic potassium hydroxide solution. Subsequently, the resulting acrylate silane is hydrolytically condensed using 28.80 g of a 0.5 molar hydrochloric acid solution. Afterwards the solvent is removed at 40° C., the product is subjected to a pressure filtration. To the encapsulation material, ferrocene is added as an initiator which is preferably dissolved in some solvent, e.g., toluene or bromobenzene in a proportion of at least 25 wt. %. Ammoniumperoxodisulfate is added to the sodium carbonate decahydrate as a hydrophilic component of the initiator system. Upon dripping the drops, the radicals required for the polymerisation of the acrylate groups are formed under co-operation of both initiator components. At the interface between PCM drops and the coating solution, the reaction takes place which forms the coating. The coated particles are separated and stored in air at room temperature.

### Example 3

Example 2 is repeated, wherein before instillation of the sodium carbonate decahydrate, 4-5 wt. % Aerosil ® 380 of Evonik are added to the encapsulation material. After four hours at 50° C, 10 ml toluene are added to the coating solution which has a volume of approx. 4 ml. The coated particles are separated by filtration, are washed with a total of approx. 30 ml toluene and are dried.

### Example 4

Example 1 was repeated, wherein, however, instead of sodium carbonate decahydrate, a mixture of 17 wt. % Na₂CO₃, 15 wt. % Na₂HPO₄ and 68 wt. % H₂O was used.

What is claimed is:

1-18. (canceled)

19. A method for producing an inorganic latent heat accumulator material which is surrounded by an encapsulation layer, wherein the encapsulation layer consists of an inorganic-organic polymer material which comprises a metal and/or half metal oxygen network Including organic groups inserted therein, wherein liquid or liquefied latent heat accumulator material is introduced into a liquid or viscous precursor material of the encapsulation material in the form of discrete units to be encapsulated, such that the encapsulation material is solidified on exterior surfaces of the latent heat accumulator material upon contact therewith, wherein the precursor material contains:
(i) at least one silane of the formula
RₐR′_{b}SiX_{4-a-b} (I)
wherein the substituents R, R′ and X may be identical or different in each case and wherein R is an organically crosslinkable radical bound to the silicon via a carbon atom, R′ is an organically not crosslinkable radical bound to the silicon via a carbon atom, X is a group which can be cleaved from silicon under hydrolytic conditions, or is OH, a is 1 or 2, b Is 0 or 2, and a+b is 1 or 2,
and optionally
(a) at least another silane of the formula (II)
SiX₄ (II)
wherein X is identical or different and has the identical meaning as in formula (I),
and/or
(b) at least another silane with the formula (III)
RₐR′^{3-a}SiX (III)
wherein R, R′ and X have the meaning given for formula (I), and/or
(c) at least one C₁-C₆-alkoxide of a metal of the III^{rd} main group, of germanium or of a metal of the II^{nd}, III^{rd}, IV^{th}, V^{th}, VI^{th}, VII^{th} and VIII^{th} subgroup
and/or
(II) a condensate or partial condensate of said silane or silanes having formula (I) and optionally of formula (II) and/or formula (III) and optionally of the alkoxide, produced by hydrolysis.

20. The method according to claim 19, wherein the precursor material contains additionally a crosslinking material.

21. The method according to claim 20, wherein the crosslinking material is organic.

22. The method according to claim 19, wherein, when the liquid or liquefied latent storage material is introduced into the precursor material, energy is Incorporated Into the precursor material In such an amount that said solidification thereof takes place.

23. The method according to claim 22, wherein at least a part of the energy is introduced in the form of conversion heat of the latent storage material.

24. The method according to claim 22, wherein at least a part of the energy is provided with the aid of a catalyst or the Initiator present in the latent storage material.

25. The method according to claim 24, wherein the catalyst or the Initiator present in the latent storage material is effective without further additions.

26. The method according to claim 24, wherein the catalyst or the initiator present In the latent storage material Is only effective in co-operation with another catalyst or initiator component present in the precursor material.

27. The method according to claim 19, wherein the liquid or viscous precursor material of the encapsulation material contains a thickener.

28. An inorganic latent heat storage material in the form of capsules surrounded by an encapsulation layer, wherein the encapsulation layer consists of an Inorganic-organic polymer material, which has been prepared from or using
(I) at least one silane of the formula
RₐR′_{b}SiX_{4-a-b} (I)
wherein the substituents R, R′ and X may be identical or different in each case and wherein R is an organically crosslinkable radical bound to the silicon via a carbon atom, R′ is an organically not crosslinkable radical bound to the silicon via a carbon atom, X is a group which can be cleaved from silicon under hydrolytic conditions, or is OH, a is 1 or 2, b Is 0 or 1, and a+b is 1 or 2, and optionally
(a) at least another silane of the formula (II)
SiX₄ (II)
wherein X is identical or different and has the identical meaning as in formula (I), and/or
(b) at least another silane with the formula (III)
RₐR′₃₋ₐSiX (III)
wherein R, R′ and X have the meaning given for formula (I), and/or
(c) at least one C₁-C₆-alkoxide of a metal of the III main group, of germanium or of a metal of the II., III., IV., V., VI., VII. and VIII. subgroup
and/or
(ii) a condensate or partial condensate of said silane or silanes having formula (I) and optionally of formula (II) and/or formula (III) and optionally of the alkoxide, produced by hydrolysis.

29. The latent heat storage material according to claim 28, wherein the heat storage material is selected from salt hydrates that are optionally diluted.

30. The latent heat storage material according to claim 28, wherein the capsules have a diameter of from 0.05 to 5 mm.

31. The latent heat storage according to claim 30, wherein the capsules have a diameter of between 0.5 and 4 mm.

32. The latent heat storage material according to claim 30, wherein the capsules have a diameter of from 0.3 to 3 mm and the encapsulation material has a thickness of from 0.05 to 0.4 mm.

33. The latent heat storage material according to claim 28, wherein the encapsulation layer is partially or completely surrounded by one or several outside layers.

34. The latent heat storage material according to claim 33, wherein said one outside layer or at least one of said several outside layers is a layer having a barrier effect in respect to water, water vapor or a gas.
